(19) United States
(12) Patent Application Publication
(10) Pub. No.: US 2012/0131393 A1
(43) Pub. Date: May 24, 2012

(54) Detecting System Component Failures In A Computing System

(75) Inventors: Paul D. Kangas, Raleigh, NC (US); Daniel M. Ranck, Cary, NC (US)

(73) Assignee: INTERNATIONAL BUSINESS MACHINES CORPORATION, Armonk, NY (US)

(21) Appl. No.: 12/950,157

(22) Filed: Nov. 19, 2010

(51) Int. Cl. G06F 11/16

(52) U.S. Cl. 714/57; 714/E11.055

(57) ABSTRACT

Detecting system component failures in a computing system, including: capturing, by a digital imaging device, an image of a component in the computing system; comparing, by a digital imaging comparator, the image of the component in the computing system to a graphical template for the component in the computing system; determining, by the digital imaging comparator, whether the image matches the graphical template for the computing system within a predetermined threshold; and sending, by a notification system, a failure event notification upon determining that the image does not match the graphical template for the computing system within the predetermined threshold.

### BACKGROUND OF THE INVENTION

1. Field of the Invention

The field of the invention is data processing, or, more specifically, methods, apparatus, and products for detecting system component failures in a computing system.

2. Description of Related Art

Modern computing systems are composed of many parts of varying complexity. In such computing systems, parts can fail, parts can be improperly configured, and the performance of such computing systems can be severely limited as a consequence. Traditional computing system diagnostics with human intervention is costly and pervasive techniques for remote trouble shooting are still very limited.

### SUMMARY OF THE INVENTION

Methods, apparatus, and products for detecting system component failures in a computing system, including: capturing, by a digital imaging device, an image of a component in the computing system; comparing, by a digital imaging comparator, the image of the component in the computing system to a graphical template for the component in the computing system; determining, by the digital imaging comparator, whether the image matches the graphical template for the computing system within a predetermined threshold; and sending, by a notification system, a failure event notification upon determining that the image does not match the graphical template for the computing system within the predetermined threshold.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in detecting system component failures in a computing system according to embodiments of the present invention.

FIG. 2 sets forth a flow chart illustrating an example method for detecting system component failures in a computing system according to embodiments of the present invention.

FIG. 3 sets forth a flow chart illustrating an example method for detecting system component failures in a computing system according to embodiments of the present invention.

FIG. 4 sets forth a flow chart illustrating an example method for detecting system component failures in a computing system according to embodiments of the present invention.

FIG. 5A sets forth a block diagram of a graphical template.

FIG. 5B sets forth a block diagram of a captured image of a properly configured component in a computing system.

FIG. 5C sets forth a block diagram of a captured image of an improperly configured component in a computing system.

### DETAILED DESCRIPTION OF EXAMPLE EMBODIMENTS

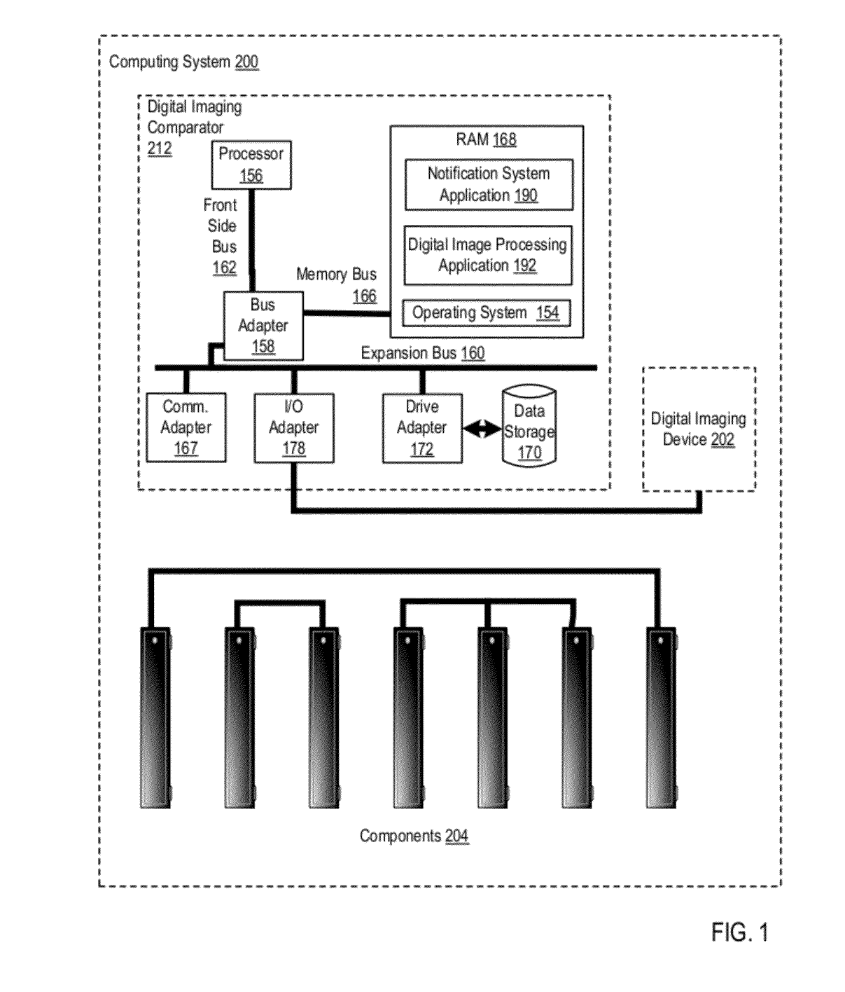

Example methods, apparatus, and products for detecting system component failures in a computing system in accordance with the present invention are described with reference to the accompanying drawings, beginning with FIG. 1. Detecting system component failures in a computing system in accordance with the present invention is generally implemented with computers, that is, with automated computing machinery. For further explanation, therefore, FIG. 1 sets forth a block diagram of automated computing machinery comprising an example computing system (200) in which system component (204) failures are identified according to embodiments of the present invention.

The computing system (200) of FIG. 1 includes one or more components (204). In the example of FIG. 1, a component (204) is any physical entity that is part of the computing system (200). In the example of FIG. 1, a component (204) may be embodied as a server, a port, a cable, a power supply, a transistor, and the like.

The computing system (200) of FIG. 1 also includes a digital imaging device (202). In the example of FIG. 1, the digital imaging device (202) is any device capable of capturing digital images. The digital imaging device (202) may be embodied as a digital camera, digital video camera, or other image sensor. Examples of image sensors include devices that include an integrated charge-coupled device (‘CCD’), active-pixel sensor (‘APS’), or complementary metal-oxide-semiconductor (‘CMOS’) sensor.

The computing system (200) of FIG. 1 also includes a digital imaging comparator (212). In the example of FIG. 1, the digital imaging comparator (212) is a module of automated computing machinery that compares one digital image to another digital image to determine the extent to which the digital images are similar. The digital imaging comparator (212) of FIG. 1 includes at least one computer processor (156) or ‘CPU’ as well as random access memory (168) (‘RAM’) which is connected through a high speed memory bus (166) and bus adapter (158) to processor (156) and to other components of the digital imaging comparator (212).

Stored in RAM (168) is a digital imaging processing application (192), a module of computer program instructions for comparing one digital image to another digital image to determine the extent to which the digital images are similar. Also stored in RAM (168) is a notification system application (190), a module of computer program instructions for generating and facilitating the transmission of event failure notifications indicating that a particular component (204) in the computing system (200) is improperly configured or malfunctioning. Also stored in RAM (168) is an operating system (154). Operating systems useful in detecting system component failures in a computing system according to embodiments of the present invention include UNIX™ Linux™ Microsoft XP™, AIX™ IBM's i5/OS™ and others as will occur to those of skill in the art. The operating system (154), the digital imaging processing application (192), and the notification system application (190) in the example of FIG. 1 are shown in RAM (168), but many components of such software typically are stored in non-volatile memory also, such as, for example, on a disk drive (170).

The digital imaging comparator (212) of FIG. 1 includes disk drive adapter (172) coupled through expansion bus (160) and bus adapter (158) to processor (156) and other components of the digital imaging comparator (212). Disk drive adapter (172) connects non-volatile data storage to the digital imaging comparator (212) in the form of disk drive (170). Disk drive adapters useful in computers for detecting system component failures in a computing system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example digital imaging comparator (212) of FIG. 1 includes one or more input/output (‘I/O’) adapters (178). I/O adapters implement user-oriented input/output through, for example, the digital imaging device (202), software drivers and computer hardware for controlling output to display devices such as computer display screens, as well as user input from user input devices (181) such as keyboards and mice. In the example of FIG. 1, the digital imaging comparator (212) receives input from the digital imaging device (202) in the form of digital images captured by the digital imaging device (202).

The example digital imaging comparator (212) of FIG. 1 includes a communications adapter (167) for data communications with other devices, such as other components (204) in the computing system (200) and for data communications with a data communications network. In particular, the digital imaging comparator (212) is coupled for data communications with data communications networks for the transmission of failure event notifications to a system administrator or other entity that monitors the computing system (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for detecting system component failures in a computing system according to embodiments of the present invention include modems for wired dial-up communications, Ethernet (IEEE 802.3) adapters for wired data communications network communications, and 802.11 adapters for wireless data communications network communications.

In the example of FIG. 1, the digital imaging comparator (212) and the digital imaging device (202) are depicted as being separate devices. Readers will appreciate that the digital imaging comparator (212) and the digital imaging device (202) may be embodied, for example, as modules within a single computing device. In the example of FIG. 1, the digital imaging comparator (212) is illustrated as including the notification system application (190). Readers will appreciate that the digital imaging comparator (212) and the notification system application (190) may reside on separate machines as well. That is, the digital imaging comparator (212), digital imaging device (202), and notification system application (190) may all reside on a single computing device or on distinct computing devices.

In the example of FIG. 1, system component (204) failures are detected in the computing system (200) by capturing, by the digital imaging device (202), an image of a component (204) in the computing system (200); comparing, by the digital imaging comparator (212), the image of the component (204) in the computing system (200) to a graphical template for the component (204) in the computing system (200); determining, by the digital imaging comparator (212), whether the image matches the graphical template for the component (204) in the computing system (200) within a predetermined threshold; and sending, by the notification system application (190), a failure event notification upon determining that the image does not match the graphical template for the component (204) in the computing system (200) within the predetermined threshold.

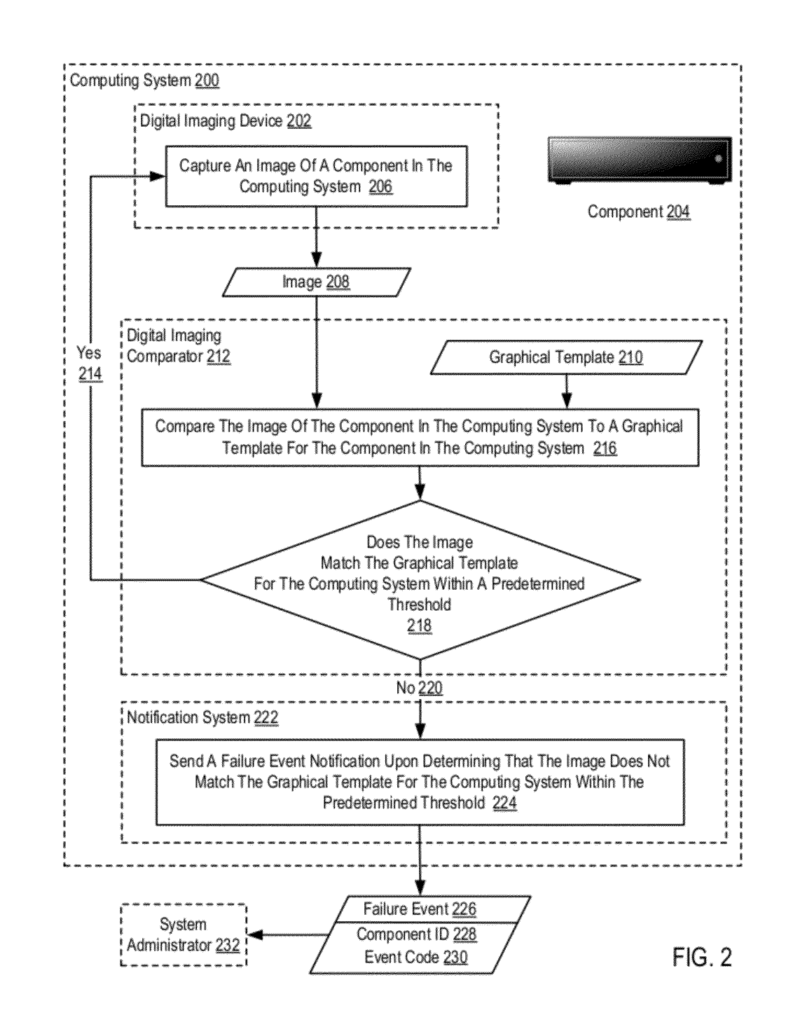

For further explanation, FIG. 2 sets forth a flow chart illustrating an example method for detecting system component failures in a computing system (200) according to embodiments of the present invention that includes capturing (206), by a digital imaging device (202), an image (208) of a component (204) in the computing system (200). A digital imaging device (202) is any device capable of capturing digital images. In the example of FIG. 2, the digital imaging device (202) may be embodied as a digital camera, digital video camera, or other image sensor. Examples of image sensors include devices that include an integrated CCD, APS, or CMOS sensor. In addition, other forms of sensors may be utilized such as, for example, infrared sensors, ultraviolet sensors, and others as will occur to those of skill in the art. A component (204) is any physical entity that is part of the computing system (200). In the example of FIG. 2, a component (204) may be embodied as a server, a port, a cable, a power supply, a transistor, and the like.

In the example of FIG. 2, capturing (206), by a digital imaging device (202), an image (208) of a component (204) in the computing system (200) can be carried out, for example, by an image sensor that captures and converts an optical image to an electrical signal. In such an embodiment, when light strikes each pixel in the image sensor, the light is held as an electrical charge that is converted to a voltage and subsequently into digital information. The collection of digital information that represents the amount of light that struck each pixel is stored as a digital image (208). Upon capturing the digital image (208), the digital image (208) is sent to or made available to a digital image comparator (212). In the example of FIG. 2, the digital image (208) may be stored in computer memory that is included as part of the digital imaging device (202) or stored in computer memory that is accessible by but distinct from the digital imaging device (202).

The example of FIG. 2 also includes comparing (216), by a digital imaging comparator (212), the image (208) of the component (204) in the computing system (200) to a graphical template (210) for the component (204) in the computing system (200). In the example of FIG. 2, the digital imaging comparator (212) is a module of automated computing machinery that compares one digital image to another digital image to determine the extent to which the digital images are similar. The digital imaging comparator (212) of FIG. 2 may be embodied as computer hardware executing digital image processing computer software.

In the example of FIG. 2, the graphical template (210) for the component (204) in the computing system (200) is a digital image of a properly configured component (204) in the computing system (200). In the example of FIG. 2, a graphical template (210) may be created, for example, by capturing a digital image of a properly configured component (204) from the same distance and perspective, relative to the component (204), as the digital imaging device (202) will be located. In such an example, the graphical template (210) can serve as a valid reference image for images (208) captured by the digital imaging device (202). For example, a graphical template (210) for a particular cable in a computing system can be embodied as a digital image of the cable that was captured when the cable was properly connected, so that the digital image serves as a reference image that indicates where the particular cable should begin, where the particular cable should terminate, the amount of slack in the particular cable, and so on. Such a graphical template (210) may be stored in computer memory included in, or accessible to, the digital imaging comparator (212).

In the example of FIG. 2, the digital imaging comparator (212) may compare the image (208) of the component (204) in the computing system (200) to a graphical template (210) for the component (204) in the computing system (200) using a digital imaging algorithm to determine the extent to which the image (208) and the graphical template (210) are similar. Such a digital imaging algorithm may include, for example, comparing the images on a pixel by pixel basis to determine how similar the image data for each pixel is, to determine the amount of pixels that are identical, to determine an average deviation between the pixels, and so on. The extent to which two pixels are identical may be determined, for example, based on the RGB color level of each pixel, based on the grayscale intensity level of each pixel, and so on. Useful digital imaging algorithms and techniques include, for example, pixelization techniques, linear filtering techniques, principal component analysis techniques, and independent component analysis techniques.

The example of FIG. 2 also includes determining (218), by the digital imaging comparator (212), whether the image (208) matches the graphical template (210) for the computing system (200) within a predetermined threshold. The predetermined threshold may be embodied as, for example, a percentage of pixels that must be identical in order for the two images to be classified as being matching images, a percentage of pixels that must be substantially similar within a predefined threshold in order for the two images to be classified as being matching images, a number of particular pixels that must be identical in order for the two images to be classified as being matching images, and so on.

In the example of FIG. 2, the predetermined threshold only be applied to a subset of pixels within the two images. For example, an image (208) captured by the digital imaging device (202) and a graphical template (210) may only include particular pixels of interest, such as pixels that represent a cable in the computing system. Although each image may also include other components in the computing system (200), such as fans, ports that are not of interest, and so on, the pixels that contain the cable are the pixels of particular interest for the purpose of determining whether the cable is properly connected. As such, the threshold and comparison of the two images may be limited to a subset of the pixels contained in each image—those pixels that should include a properly connected cable.

In the example of FIG. 2, when it is determined that the image (208) does match (214) the graphical template (210), or is sufficiently identical to the graphical template (210), the method depicted in FIG. 2 returns flow control to the digital imaging device (202) which will subsequently capture (206) an additional image of the component (204), for example, upon the expiration of some predetermined interval. Alternatively, when it is determined that the image (208) does not match (220) the graphical template (210), the method depicted in FIG. 2 includes sending (224), by a notification system (222), a failure event notification (226) upon determining that the image (208) does not match the graphical template (210) within the predetermined threshold. The notification system (222) of FIG. 2 is automated computing machinery capable of communicating with a notification receipt such as, for example, a system administrator (232), an error log, a notification repository, and so on.

In the example of FIG. 2, sending (224), by the notification system (222), a failure event notification (226) upon determining that the image (208) does not match the graphical template (210) for the component (204) in the computing system (200) within the predetermined threshold may be carried out, for example, by constructing an email message, a short message service (‘SMS’) message, an instant message, or other form of message over an appropriate data communications network to the system administrator (232). In the example of FIG. 2, the failure event notification (226) includes an identification (228) of the component (204) captured in the image (208) and an event code (230) identifying a failure type. For example, the failure event notification (226) may include an identification (228) representing a particular Ethernet cable and an event code (230) that identifies that failure type as a ‘cable unplugged’ failure. Such a failure event notification (226) may be used, for example, by the system administrator (232) to identify a problem in the computing system (200) so that the system administrator (232) can take a corrective action such as plugging the cable back in.

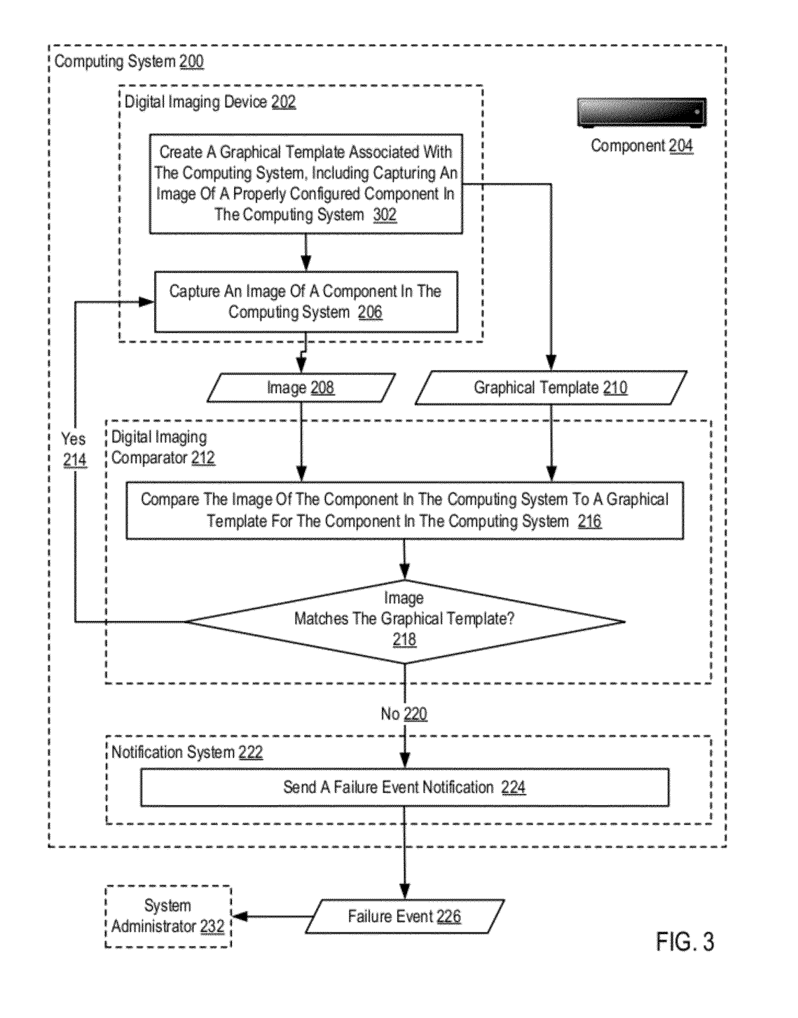

For further explanation, FIG. 3 sets forth a flow chart illustrating a further example method for detecting system component failures in a computing system according to embodiments of the present invention. FIG. 3 is similar to FIG. 2 as it also includes:
capturing (206), by a digital imaging device (202), an image (208) of a component (204) in the computing system (200),
comparing (216), by a digital imaging comparator (212), the image (208) of the component (204) in the computing system (200) to a graphical template (210) for the component (204) in the computing system (200),
determining (218), by the digital imaging comparator (212), whether the image (208) matches the graphical template (210) for the component (204) in the computing system (200) within a predetermined threshold, and
sending (224), by a notification system (222), a failure event notification (226) upon determining that the image does not match (220) the graphical template (210) for the component (204) in the computing system (200) within the predetermined threshold.

The example of FIG. 3 also includes creating (302) a graphical template (210) associated with the component (204) in the computing system (200), including capturing, by the digital imaging device (202), an image of a properly configured component (204) in the computing system (200). Because the digital imaging device (202) captures the image that will be used as the graphical template (210), the captured image of the properly configured component (204) will be taken from the same distance and perspective, relative to the component (204), as test images that are subsequently captured by the digital imaging device (202). In such an example, the graphical template (210) can serve as a valid reference image for images (208) captured by the digital imaging device (202).

For example, a graphical template (210) for a particular cable in the computing system (200) can be embodied as a digital image of the cable that was captured when the cable was properly connected, so that the graphical template (210) serves as a reference image that indicates where the particular cable should begin, where the particular cable should terminate, the amount of slack in the particular cable, and so on. As such, a comparison between the graphical template (210) and a subsequently captured image (208) can be used to determine if the cable is still properly configured. That is, the graphical template (210) and a subsequently captured image (208) can be used to determine, for example, whether the cable terminates at the same location in each image, whether the cable originates at the same location in each image, whether the cable has the same amount of slack in each image, and so on. Any deviation between the images, or at least the portions of the images in which the cable is depicted, can be used as an indication that the cable has moved. Some movement may be deemed acceptable while other movement, such as a change in the locations in which the cable originates or terminates, may be unacceptable as this movement indicates that the cable has become unplugged from its desired origination and termination locations.

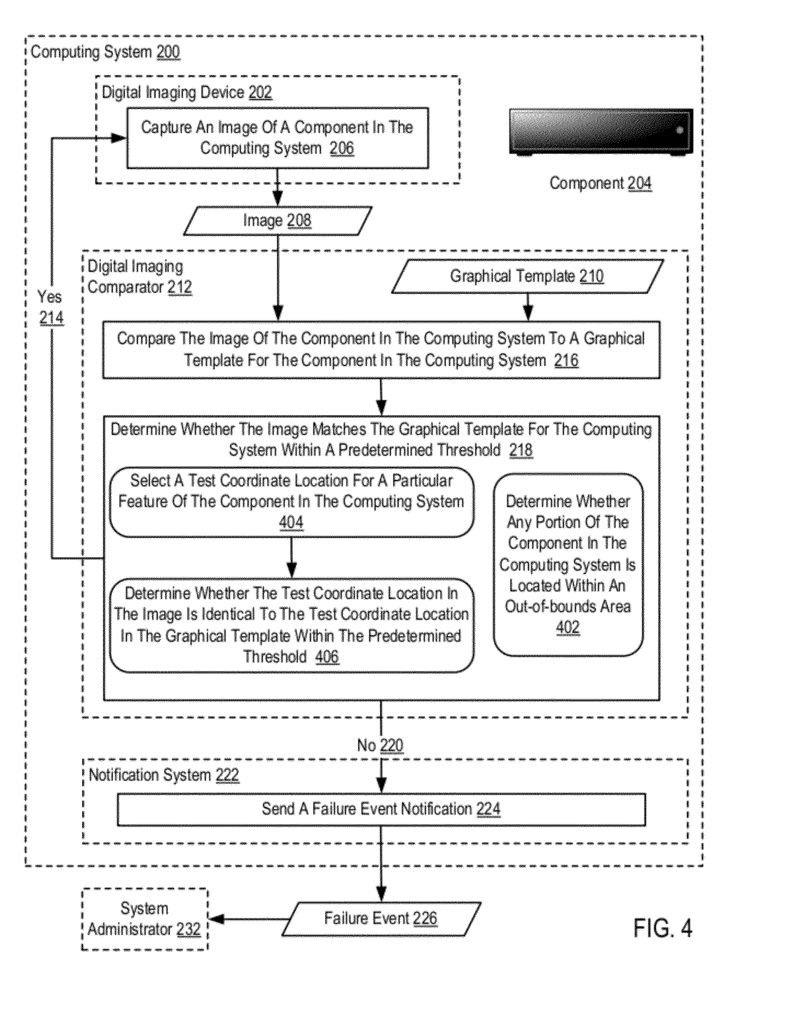

For further explanation, FIG. 4 sets forth a flow chart illustrating a further example method for detecting system component failures in a computing system according to embodiments of the present invention. FIG. 4 is similar to FIG. 2 and FIG. 3 as it also includes:
capturing (206), by a digital imaging device (202), an image (208) of a component (204) in the computing system (200),
comparing (216), by a digital imaging comparator (212), the image (208) of the component (204) in the computing system (200) to a graphical template (210) for the component (204) in the computing system (200),
determining (218), by the digital imaging comparator (212), whether the image (208) matches the graphical template (210) for the component (204) in the computing system (200) within a predetermined threshold, and
sending (224), by a notification system (222), a failure event notification (226) upon determining that the image does not match (220) the graphical template (210) for the component (204) in the computing system (200) within the predetermined threshold.

In the example of FIG. 4 determining (218) whether the image (208) matches the graphical template (210) for the component (204) in the computing system (200) within a predetermined threshold can include determining (402) whether any portion of the component (204) in the computing system (200) is located within an out-of-bounds area. An out-of-bounds area represents a section of the image (208) that a properly functioning component (204) cannot reside within. An area may be identified as being an out-of-bounds area because, for example, the presence of a particular component (204) in the out-of-bounds area may indicate that the component (204) is not properly configured. For example, if a cable resides in the out-of-bounds area, this may indicate that the cable is not properly connected. In addition, an area may be identified as being an out-of-bounds area because the presence of a particular component (204) in the out-of-bounds area may indicate that the component (204) is subject to potential failures. For example, if a cable resides in the out-of-bounds area, this may indicate that the cable is in physical contact with a heat sink and thereby exposed to a heat source that can melt the cable and cause the cable to become inoperable.

Consider an example in which the component (204) being monitored is a cable that runs between two other components, such as two servers, in the computing system (200). Based on the arrangement of the components (204) within the computing system (200), the position of the digital imaging device (202), the resolution of the digital imaging device (202), and other factors, the component (204) being monitored can be expected to be depicted within a certain subset of pixels in a captured image (208). For example, if the captured image (208) has a height (‘Y-axis’) of 1000 pixels and a width (‘X-axis’) of 2000 pixels, a properly connected cable may be depicted as residing within pixels 200-800 on the X-axis and pixels 350-375 on the Y-axis. In such an example, pixels 0-199 and pixels 801-1999 on the X-axis, and pixels 0-349 and pixels 376-999 can be considered as the out-of-bounds area, indicating that the cable is not properly connected when the cable resides in the out-of-bounds area. In such an example, determining (402) whether any portion of the component (204) in the computing system (200) is located within an out-of-bounds area can be carried out by examining the image (208) to determine if the cable resides in the out-of-bounds area.

In the example of FIG. 4 determining (218) whether the image (208) matches the graphical template (210) for the component (204) in the computing system (200) within a predetermined threshold can alternatively include selecting (404) a test coordinate location for a particular feature of the component (204) in the computing system (200) and determining (406) whether the test coordinate location in the image (208) is identical to the test coordinate location in the graphical template (210) within the predetermined threshold. Using the example of the cable described in the previous paragraph, the test coordinate location would be set to pixels 200-800 on the X-axis and pixels 350-375 on the Y-axis, given that the cable is expected to reside within these pixels in an image (208) captured by the digital imaging device (202). In such an example, the digital imaging comparator (212) can compare pixels 200-800 on the X-axis and pixels 350-375 on the Y-axis in the image (208) captured by the digital imaging device (202) to pixels 200-800 on the X-axis and pixels 350-375 on the Y-axis in the graphical template (210), on a pixel-by-pixel basis, to determine what percentage of these pixels are identical or sufficiently similar. In such an example, if the percentage of test pixels that are identical or sufficiently similar in each image is above the predetermined threshold, the cable is characterized as being properly configured. However, if the percentage of test pixels that are identical or sufficiently similar in each image is below the predetermined threshold, the cable is characterized as being improperly configured and a failure event notification (226) is sent (224).

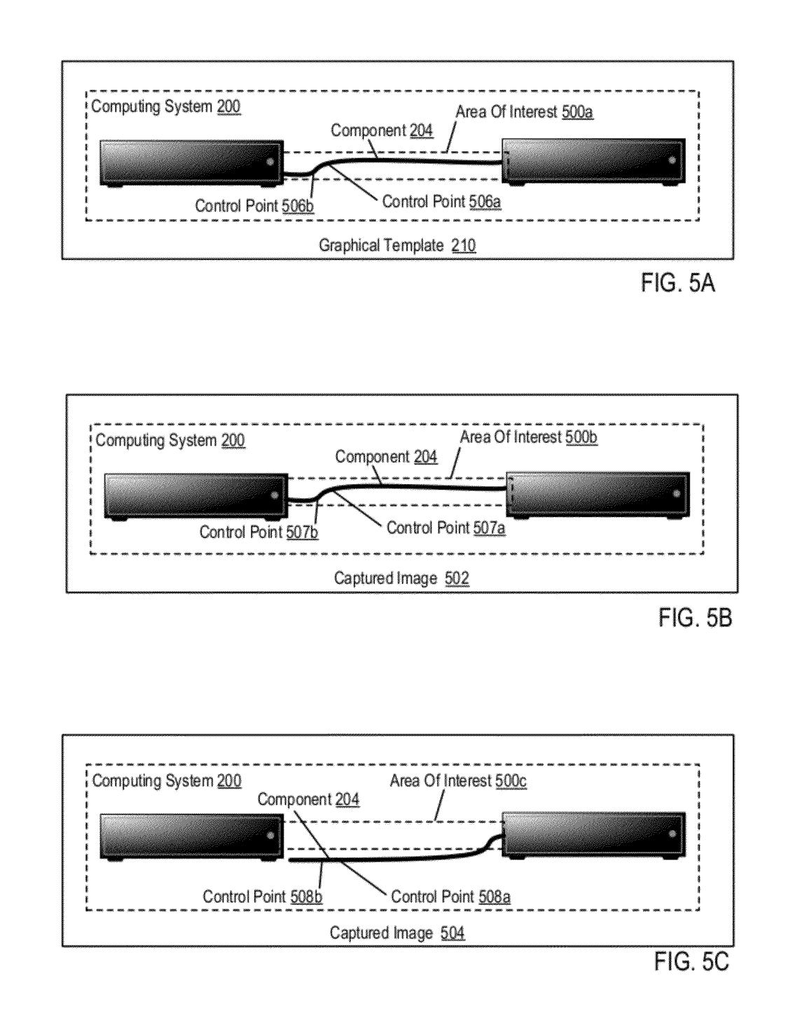

For further explanation, FIG. 5A sets forth a block diagram of a graphical template (210). In the example of FIG. 5A, the graphical template (210) is embodied as a digital image of a component (204) in a computing system (200). The example of FIG. 5A depicts an embodiment in which the component (204) of interest is a cable connecting two other components in the computing system (200). In the example of FIG. 5A, the area of the digital image in which the component (204) of interest resides is characterized as the area of interest (500a). That is, in the illustrated graphical template (210), the main area of interest is the portion of the digital image in which the component (204) of interest resides. In such an example, all areas of the graphical template (210) that are outside of the area of interest (500a) may be characterized as an out-of-bounds area, as the component (204) of interest should not reside in the out-of-bounds area when the component (204) of interest is properly configured—when the component (204) of interest is connecting the other components in the computing system (200).

In the example of FIG. 5A, two control points (506a, 506b) are identified within the component (204). In the example of FIG. 5A, each control point (506a, 506b) may be used to determine whether a particular component (204), while residing within the area of interest (500a), is configured as desired. For example, a particular cable running between two devices may be bent at certain points so that the cable can avoid coming into physical contact with some other component, such as a heat sink, that can damage the cable. In such an example, the control points (506a, 506b) may be used to determine whether the cable is configured so as to avoid physical contact with the heat sink. By comparing the location of the control points (506a, 506b) in the graphical template (210) to the control points in a captured image, additional analysis can occur regarding whether a component (204) is properly configured, beyond a determination regarding whether the component (204) is within a particular region. In the example of FIG. 5A, the control points (506a, 506b) may also be associated with a configurable tolerance, such that a comparison between the location of the control points (506a, 506b) in the graphical template (210) and the location of the control points in a captured image would be deemed as matching so long as the control points (506a, 506b) in the graphical template (210) and the control points in a captured image were identical within the configurable tolerance.

For further explanation, FIG. 5B sets forth a block diagram of a captured image (502) of a properly configured component (204) in a computing system (200). FIG. 5B represents the same computing system (200) that is depicted in FIG. 5A. In the example of FIG. 5B, the component (204) of interest is properly configured, and as such, the area of interest (500a) in the graphical template (210) is sufficiently identical to the area of interest (500b) in the captured image (504). A comparison between the area of interest (500a) in the graphical template (210) and the area of interest (500b) in the captured image (504) would therefore yield a match, such that the component (204) is characterized as being properly configured. Likewise, an examination of any out-of-bounds area would determine that the cable is not in the out-of-bounds area, such that the component (204) is characterized as being properly configured.

In the example of FIG. 5B, the two control points (507a, 507b) are identified within the component (204). In the example of FIG. 5B, the component (204) of interest is properly configured, and as such, the control points (506a, 506b) in the graphical template (210) are sufficiently identical to the control points (507a, 507b) in the captured image (502). A comparison between the control points (506a, 506b) in the graphical template (210) and control points (507a, 507b) in the captured image (502) would therefore yield a match, such that the component (204) is characterized as being properly configured.

For further explanation, FIG. 5C sets forth a block diagram of a captured image (504) of an improperly configured component (204) in a computing system (200).

FIG. 5C represents the same computing system (200) that is depicted in FIG. 5A. In the example of FIG. 5C, however, the component (204) of interest is improperly configured as the cable is not connected to both of the other components in the computing system (200). As such, the area of interest (500a) in the graphical template (210) is not identical to the area of interest (500c) in the captured image (506). A comparison between the area of interest (500a) in the graphical template (210) and the area of interest (500c) in the captured image (506) would therefore fail to yield a match, such that the component (204) is characterized as being improperly configured. Likewise, an examination of any out-of-bounds area would determine that the cable is in the out-of-bounds area, such that the component (204) is characterized as being improperly configured. In the example of FIG. 5C, because the component (204) of interest is improperly configured, a comparison between the control points (506a, 506b) in the graphical template (210) and control points (508a, 508b) in the captured image (504) would also fail to yield a match, such that the component (204) is characterized as being improperly configured.

Example embodiments of the present invention are described largely in the context of a fully functional computer system for detecting system component failures in a computing system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of detecting system component failures in a computing system, the method comprising:
capturing, by a digital imaging device, an image of a component in the computing system;
comparing, by a digital imaging comparator, the image of the component in the computing system to a graphical template for the component in the computing system;
determining, by the digital imaging comparator, whether the image matches the graphical template for the component in the computing system within a predetermined threshold; and
sending, by a notification system, a failure event notification upon determining that the image does not match the graphical template for the component in the computing system within the predetermined threshold.

2. The method of claim 1 wherein the failure event notification includes an identification of the component and an event code identifying a failure type.

3. The method of claim 1 further comprising creating a graphical template associated with the component in the computing system, including capturing, by the digital imaging device, an image of a properly configured component in the computing system.

4. The method of claim 1 wherein determining whether the image matches the graphical template for the computing system within the predetermined threshold further comprises determining whether any portion of the component in the computing system is located within an out-of-bounds area.

5. The method of claim 1 wherein determining whether the image matches the graphical template for the computing system within the predetermined threshold further comprises:
selecting a test coordinate location for a particular feature of the component in the computing system; and
determining whether the test coordinate location in the image is identical to the test coordinate location in the graphical template within the predetermined threshold.

6. Apparatus for detecting system component failures in a computing system, the apparatus comprising a computer processor, a computer memory operatively coupled to the computer processor, the computer memory having disposed within it computer program instructions that, when executed by the computer processor, carry out the steps of:
capturing, by a digital imaging device, an image of a component in the computing system;
comparing, by a digital imaging comparator, the image of the component in the computing system to a graphical template for the component in the computing system;
determining, by the digital imaging comparator, whether the image matches the graphical template for the component in the computing system within a predetermined threshold; and
sending, by a notification system, a failure event notification upon determining that the image does not match the graphical template for the component in the computing system within the predetermined threshold.

7. The apparatus of claim 6 wherein the failure event notification includes an identification of the component and an event code identifying a failure type.

8. The apparatus of claim 6 further comprising computer program instructions that, when executed by the computer processor, carry out the step of creating a graphical template associated with the component in the computing system, including capturing, by the digital imaging device, an image of a properly configured component in the computing system.

9. The apparatus of claim 6 wherein determining whether the image matches the graphical template for the computing system within the predetermined threshold further comprises determining whether any portion of the component in the computing system is located within an out-of-bounds area.

10. The apparatus of claim 6 wherein determining whether the image matches the graphical template for the computing system within the predetermined threshold further comprises:
selecting a test coordinate location for a particular feature of the component in the computing system; and
determining whether the test coordinate location in the image is identical to the test coordinate location in the graphical template within the predetermined threshold.

11. A computer program product for detecting system component failures in a computing system, the computer program product disposed upon a computer readable storage medium, the computer program product comprising computer program instructions that, when executed, cause a computer to carry out the steps of:
capturing, by a digital imaging device, an image of a component in the computing system;
comparing, by a digital imaging comparator, the image of the component in the computing system to a graphical template for the component in the computing system;
determining, by the digital imaging comparator, whether the image matches the graphical template for the component in the computing system within a predetermined threshold; and
sending, by a notification system, a failure event notification upon determining that the image does not match the graphical template for the component in the computing system within the predetermined threshold.

12. The computer program product of claim 11 wherein the failure event notification includes an identification of the component and an event code identifying a failure type.

13. The computer program product of claim 11 further comprising computer program instructions that, when executed, cause a computer to carry out the step of creating a graphical template associated with the component in the computing system, including capturing, by the digital imaging device, an image of a properly configured component in the computing system.

14. The computer program product of claim 11 wherein determining whether the image matches the graphical template for the computing system within the predetermined threshold further comprises determining whether any portion of the component in the computing system is located within an out-of-bounds area.

15. The computer program product of claim 11 determining whether the image matches the graphical template for the computing system within the predetermined threshold further comprises:
selecting a test coordinate location for a particular feature of the component in the computing system; and
determining whether the test coordinate location in the image is identical to the test coordinate location in the graphical template within the predetermined threshold.
